(19) United States
(12) Patent Application Publication
(10) Pub. No.: US 2024/0316537 A1
(43) Pub. Date: Sep. 26, 2024

(54) REVERSIBLE HYDROGEN STORAGE OF AMORPHOUS C60 FULLERENE WITH CARBON DEFECT FACILITATED BY ATOMIC Pt-MEDIATED HYDROGEN SPILLOVER IN AMBIENT CONDITION

(71) Applicant: KOREA ADVANCED INSTITUTE OF SCIENCE AND TECHNOLOGY, Daejeon (KR)

(72) Inventors: Jeung Ku Kang, Daejeon (KR); Hee Bin Lee, Daejeon (KR); Dong Gyu Park, Daejeon (KR)

(21) Appl. No.: 18/189,151

(22) Filed: Mar. 23, 2023

(51) Int. Cl. B01J 23/42; B01J 21/18; B01J 35/30; B01J 35/45; B01J 35/52; B01J 35/61; B01J 37/02; B01J 37/04; B01J 37/10; C01B 3/00

(52) U.S. Cl. CPC B01J 23/42; B01J 21/18; B01J 35/393; B01J 35/45; B01J 35/52; B01J 35/613; B01J 35/615; B01J 35/617; B01J 37/0209; B01J 37/04; B01J 37/10; C01B 3/0026

(57) ABSTRACT

The present disclosure relates to an amorphous catalyst composite, including an amorphous isotropic carbon compound with a carbon defect and a nanoparticle, and a method of preparing the same.

### TECHNICAL FIELD

The present disclosure relates to an amorphous catalyst composite, including an amorphous isotropic carbon compound with a carbon defect and a nanoparticle, and a method of preparing the same.

### BACKGROUND

The usage of fossil fuels has increased rapidly as the energy demand increases gradually. Consequently, the carbon dioxide which is regarded as a greenhouse gas is accumulated in the atmosphere and the atmospheric temperature rises continuously due to the greenhouse effect, resulting the rapid climate change being observed in all over the world. To overcome the crisis concerned with the climate change, several efforts have been made to replace fossil fuels to the alternative energy. Among the various alternative energy sources, the hydrogen energy is a promising energy source due to its high energy density (142 MJ kg⁻¹) compared to that of gasoline (46 MJ kg⁻¹). During the combustion in such as fuel cell, hydrogen molecules react with oxygen molecules and produce only water, which is eco-friendly. However, the absence of a viable, safe, easy and cost-effective strategy for hydrogen storage is one of the critical barriers for the proposed economy. In addition, on-board hydrogen storage continues to be challenging because gaseous hydrogen must be contained in a small volume without adding significant weight to the vehicle.

One of the goals of the hydrogen storage system is to find materials with an enthalpy for hydrogen adsorption between 15 kJ/mol and 20 kJ/mol at ambient conditions. Among a wide range of potential materials for hydrogen storage, carbon-based systems have received tremendous research interest due to their low mass density, high surface area, and chemical stability. However, common carbon materials and other porous materials inducing hydrogen physisorption have lower storage capacity due to weak van der Waals forces between the adsorbent and hydrogen molecules. Because they have a fairly low enthalpy of hydrogen bonding (<10 kJ/mol), they are too weak to adsorb hydrogen.

To overcome these shortcomings, there has been an attempt to use a metal catalyst in hydrogen storage materials to improve hydrogen storage capacity at room temperature. However, the structural stability of dispersed metal catalysts still remains a major problem because metal atoms tend to aggregate due to their strong cohesion.

### PRIOR ART LITERATURE

[Patent literature] Korean Patent Laid-open Publication No. 10-2021-0108301

### DISCLOSURE OF THE INVENTION

### Problems to be Solved by the Invention

The present disclosure provides an amorphous catalyst composite, using an amorphous isotropic carbon compound with a carbon defect to improve the structural stability of a dispersed metal catalyst, and a method of preparing the same.

However, problems to be solved by the present disclosure are not limited to the above-described problems. Although not described herein, other problems to be solved by the present disclosure can be clearly understood by a person with ordinary skill in the art from the following descriptions.

### Means for Solving the Problems

A first aspect of the present disclosure provides an amorphous catalyst composite, including an amorphous isotropic carbon compound with a carbon defect; and a nanoparticle located at the carbon defect.

A second aspect of the present disclosure provides a method of preparing an amorphous catalyst composite, including a process of dispersing a crystalline isotropic carbon compound in an alkaline solution; a process of obtaining and calcining the dispersed material to obtain an amorphous isotropic carbon compound with a carbon defect; and a process of impregnating the obtained amorphous isotropic carbon compound in a solution containing a nanoparticle precursor.

### Effects of the Invention

In an amorphous catalyst composite according to embodiments of the present disclosure, an amorphous isotropic carbon compound with a carbon defect imparts stability to a nanoparticle, which can serve as an active catalyst, due to the carbon defect on its surface and thus can suppress aggregation of the nanoparticle.

In the amorphous catalyst composite according to embodiments of the present disclosure, the nanoparticle bound to the carbon defect is atomic scale and thus can readily serve as an active catalyst of a desired reaction (for non-limiting example, hydrogen adsorption and desorption). Also, the amorphous isotropic carbon compound has a high specific surface area and a high pore volume and thus can provide a high storage capacity for a target material (for non-limiting example, hydrogen atoms).

### BRIEF DESCRIPTION OF THE DRAWINGS

FIGS. 1A to 1H show schematic illustrations of (FIG. 1A) a difference between crystalline C₆₀ fullerene and amorphous C₆₀₋ₓ and (FIG. 1B) a description of hydrogen diffusion behavior at enlarged amorphous C₆₀₋ₓ, (FIGS. 1C and 1D) transmission electron microscope (TEM) images, (FIG. 1E) a Raman spectroscopy, (FIG. 1F) a X-ray photoelectron spectroscopy (XPS) C 1s scan, (FIG. 1G) a C K-edge of the X-ray absorption near edge structure (NEXAFS), and (FIG. 1H) an electron spin resonance (ESR) of crystalline C₆₀ fullerene and amorphous C₆₀₋ₓ, in accordance with an example of the present disclosure.

FIGS. 2A to 2D show transmission electron microscopy (TEM) images of C₆₀₋ₓ activated at a certain KOH concentration, in accordance with an example of the present disclosure: Those for (FIG. 2A) a pristine C₆₀, (FIG. 2B) 0.05 M KOH, (FIG. 2C) 0.1 M KOH, and (FIG. 2D) 1 M KOH.

FIGS. 3A to 3F show (FIG. 3A) a high-angle annular dark field-scanning transmission electron microscopy (HAADF-STEM) image of Pt—C₆₀₋ₓ, (FIG. 3B) X-ray diffraction patterns, (FIG. 3C) isotherm N₂ adsorption/desorption curves and (FIG. 3D) corresponding pore distribution curves of crystalline C₆₀ fullerene and amorphous C₆₀₋ₓ, (FIG. 3E) a schematic illustration of atomic Pt-anchored C₆₀₋ₓ, (FIG. 3F) and a schematic illustration of corresponding hydrogen spillover phenomenon occurring on Pt—C₆₀₋ₓ. FIGS. 3G(i) to 3G(vi) show three models of Pt-doped defect C₅₄ with top views and side views (Pt: light gray, C: dark gray and middle gray), in accordance with an example of the present disclosure.

FIGS. 4A to 4D show (FIG. 4A) a HAADF-STEM image and (FIGS. 4B to 4D) EDS mapping images of synthesized Pt—C₆₀₋ₓ, in accordance with an example of the present disclosure.

FIG. 5 shows X-ray photoelectron spectroscopy (XPS) spectra of Pt—C₆₀₋ₓ and C₆₀ fullerene, in accordance with an example of the present disclosure.

FIGS. 6A and 6B show (FIG. 6A) nitrogen adsorption-desorption isotherm curves and (FIG. 6B) micropore distribution curves of C₆₀₋ₓ and Pt—C₆₀₋ₓ, in accordance with an example of the present disclosure.

FIGS. 7A to 7C show (FIG. 7A) a structure of fullerene with defect sites highlighted, (FIG. 7B) a structure of the defect fullerene C₅₄ with dangling carbons highlighted, and (FIG. 7C) an optimized structure of (B) which is the dangling carbons connected each other to make 4-membered ring and 9-membered ring, in accordance with an example of the present disclosure.

FIGS. 8A(i), 8A(ii), 8B(i), 8B(ii), 8C(i), 8C(ii), 8D(i), and 8D(ii) show schematic illustrations of several configurations of Pt-doped defect fullerene (C₅₄) (Pt: light gray, C: dark gray), in accordance with an example of the present disclosure.

FIG. 9 shows a graph of binding energy (BE) of Pt on C₅₄, in accordance with an example of the present disclosure: The labels of x-axis (Pt anchoring site, corresponding to each model of FIGS. 8A(i), 8A(ii), 8B(i), 8B(ii), 8C(i), 8C(ii), 8D(i), and 8D(ii) and generic C₆₀) are adopted from FIGS. 8A(i), 8A(ii), 8B(i), 8B(ii), 8C(i), 8C(ii), 8D(i), and 8D(ii), and binding energy (BE) is averaged as for the top and bottom configurations. BE of the pristine C₆₀ is also averaged for (6,6)- and (6,5)-edges of which BE's are 3.46 Ev and 3.00 Ev, respectively.

FIGS. 10A(i), 10A(ii), 10B(i), 10B(ii), 10C(i), and 10C(ii) show schematic illustrations of the different binding mode of Pt on the curved C materials, in accordance with an example of the present disclosure: (FIGS. 10A(i) and 10A(ii)) Pt anchors the edge of C₆₀ without any significant structural change of the support (Δd(C−C)=0.104 Å) (Pt: light gray and highlighted, C: black), (FIGS. 10B(i) and 10B(ii)) Pt intrudes (6,6)-edge next to the defect area of C₅₄, where C—C bond is broken into the distance of 2.704 Å and Pt makes 7-membered ring (The highlighted C's denote the defect region), (Pt: light gray and highlighted, C: dark gray), and (FIGS. 10C(i) and 10C(ii)) Pt is embedded in a vacancy site of a nanohorn model where Pt is bound to the dangling carbons (Pt: black, C: gray).

FIGS. 11A to 11C shows (FIG. 11A) a EDS analysis graph of Pt—C₆₀₋ₓ, (FIG. 11B) a HAADF-STEM image of Pt—C₆₀₋ₓ, and (FIG. 11C) a Pt element EDS mapping image of Pt—C₆₀₋ₓ, in accordance with an example of the present disclosure.

FIGS. 12A to 12D shows (FIG. 12A) a comparison of hydrogen storage capacity between Pt—C₆₀₋ₓ and C₆₀ fullerene, (FIG. 12B) a mass spectroscopy of hydrogen during the temperature programmed desorption(TPD), and graphs of the cycle performance of (FIG. 12C) adsorption with pressure and (FIG. 12D) desorption with time, in accordance with an example of the present disclosure.

FIGS. 13A(i) to 13A(x viii) and 13B show (FIGS. 13A(i) to 13A(x viii)) the optimized geometries of Pt(9,6)—C₆₀₋ₓ, Pt(6,6)—C₆₀₋ₓ, and Pt(5,4)—C₆₀₋ₓ following H₂-spillover pathway and (FIG. 13B) their energy profile, in accordance with an example of the present disclosure (Ads stands for H₂ adsorption state and M does for the migration state of H atom. Pt: light gray, C: dark gray and middle gray, H: white).

FIGS. 14A to 14C show schematic illustrations of the optimized structure of Model-C in the H-spillover mechanism, in accordance with an example of the present disclosure: (FIG. 14A) Ads2 stands for the state of 2 H₂ molecules are adsorbed. (FIG. 14B) M1 and (FIG. 14C) M3 are those of the 1^{st} and 3^{rd} migration state of H atom. (The highlighted atoms denote the original Pt support atoms. Only carbons related to the defect region (middle gray) and the faces with Pt-doped edge (dark gray) are presented for clarity. Pt: light gray, C: dark gray and middle gray, H: white.)

FIGS. 15A(i) to 15A(x iv) show schematic illustrations of the optimized structure following H-spillover pathway where H atom migrate to intact area (FIGS. 15A(i) to 15A(vii)) and defect region (FIGS. 15A(viii) to 15A(x iv)) (Only carbons related to the defect region (middle gray) and the faces with Pt-doped edge (dark gray) are presented for clarity. Pt: light gray, C: dark gray and middle gray, H: white.). FIG. 15B shows the correspond enthalpy of each state, in accordance with an example of the present disclosure.

### DETAILED DESCRIPTION

Throughout the whole document, the term “connected to” may be used to designate a connection or coupling of one element to another element and includes both an element being “directly connected to” another element and an element being “electronically connected to” another element via another element.

Through the whole document, the term “on” that is used to designate a position of one element with respect to another element includes both a case that the one element is adjacent to the other element and a case that any other element exists between these two elements.

Further, it is to be understood that the term “comprises or includes” and/or “comprising or including” used in the document means that one or more other components, steps, operation and/or the existence or addition of elements are not excluded from the described components, steps, operation and/or elements unless context dictates otherwise; and is not intended to preclude the possibility that one or more other features, numbers, steps, operations, components, parts, or combinations thereof may exist or may be added.

The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

Through the whole document, a phrase of “(n,m)-edge” is referred to as the edge made by two faces of n-membered and m-membered rings.

Hereinafter, embodiments and embodiments of the present disclosure will be described in detail with reference to the accompanying drawings. However, the present disclosure may not be limited to the following embodiments, embodiments, and drawings.

A first aspect of the present disclosure provides an amorphous catalyst composite, including an amorphous isotropic carbon compound with a carbon defect; and a nanoparticle located at the carbon defect.

In an embodiment of the present disclosure, the amorphous isotropic carbon compound may include a homogeneous carbon compound having a hollow sphere shape, an ellipsoid shape, or a tube shape.

In an embodiment of the present disclosure, the homogeneous carbon compound having the hollow sphere shape may include at least one selected from C₆₀ fullerene, C₇₀ fullerene, C₇₂ fullerene, C₇₆ fullerene, C₈₄ fullerene, and C₁₁₀ fullerene, but may not be limited thereto. Specifically, the homogeneous carbon compound having the hollow sphere shape occupies a smaller volume per unit weight and thus has a lower frequency of inhibiting transfer of a material such as hydrogen molecules compared to the other shapes such as a tube shape. Therefore, the homogeneous carbon compound having the hollow sphere shape facilitates significantly excellent catalysis and target material storage compared to the other shapes such as a tube shape.

In an embodiment of the present disclosure, the nanoparticle may be atomic scale. Specifically, the amorphous isotropic carbon compound has a carbon defect on its surface, and the amorphous isotropic carbon compound may include a dangling bond and an unsaturated orbital caused by the carbon defect, or both of them. The dangling bond and the unsaturated orbital caused by the carbon defect may provide high affinity between the nanoparticle and the amorphous isotropic carbon compound. Thus, although the nanoparticle is atomic scale, it can be stably bound to the amorphous isotropic carbon compound. That is, the amorphous isotropic carbon compound with the carbon defect may serve as a support for imparting stability to the nanoparticle.

In an embodiment of the present disclosure, the nanoparticle may include at least one selected from Pt, Fe, Ni, Mo, Pd, Ru, Re, Cu, Mg, Ca, Sr, Ba, Mn, Co, Zn and Cd, but may not be limited thereto. In an embodiment of the present disclosure, the nanoparticle may be a single metal. For example, the nanoparticle may be Pt, which is a metal that can be used for hydrogen adsorption and desorption.

In an embodiment of the present disclosure, an amount of the nanoparticle may be about 0.001 part by weight to about 10 parts by weight with respect to 100 parts by weight of the amorphous isotropic carbon compound. For example, the amount of the nanoparticle may be about 0.001 part by weight to about 10 parts by weight, about 0.001 part by weight to about 5 parts by weight, about 0.1 part by weight to about 10 parts by weight, about 0.1 part by weight to about 5 parts by weight, about 1 part by weight to about 10 parts by weight, about 1 part by weight to about 5 parts by weight, or about 1 part by weight to about 4 parts by weight with respect to 100 parts by weight of the amorphous isotropic carbon compound. In an embodiment of the present disclosure, if the amount of the nanoparticles is greater than about 10 parts by weight with respect to 100 parts by weight of the amorphous isotropic carbon compound, the nanoparticle may not be atomic scale, but may be excessively aggregated, which may cause a structural instability. If the amount of the nanoparticle is smaller than about 0.001 part by weight with respect to 100 parts by weight of the amorphous isotropic carbon compound, the catalytic performance of the nanoparticle may be degraded. In an embodiment of the present disclosure, an optimal amount of the nanoparticle in the amorphous isotropic carbon compound for high capacity hydrogen storage may be about 1 part by weight to about 4 parts by weight, or about 1 part by weight to about 5 parts by weight with respect to 100 parts by weight of the amorphous isotropic carbon compound. In spite of a very small amount of the nanoparticle, the nanoparticle may exhibit excellent catalytic performance and thus may facilitate high capacity hydrogen storage.

In an embodiment of the present disclosure, an atomic ratio of the amorphous isotropic carbon compound and the nanoparticle may be about 100:0.01 to about 100:1, about 100:0.01 to about 100:0.5, about 100:0.01 to about 100:0.3, about 100:0.01 to about 100:0.26, about 100:0.1 to about 100:1, about 100:0.1 to about 100:0.5, or about 100:0.1 to about 100:0.3.

In an embodiment of the present disclosure, a specific surface area of the amorphous isotropic carbon compound may be about 50 m²/g to about 500 m²/g. Specifically, the specific surface area of the amorphous isotropic carbon compound may be about 50 m²/g to about 500 m²/g, about 50 m²/g to about 400 m²/g, about 50 m²/g to about 300 m²/g, about 100 m²/g to about 500 m²/g, about 100 m²/g to about 400 m²/g, about 100 m²/g to about 300 m²/g, about 200 m²/g to about 500 m²/g, about 200 m²/g to about 400 m²/g, about 200 m²/g to about 300 m²/g, or about 200 m²/g to about 250 m²/g, but may not be limited thereto. The amorphous isotropic carbon compound may have a higher specific surface area than a crystalline isotropic carbon compound due to a carbon defect present on its surface. The high specific surface area may provide a large binding site for the nanoparticle, and may also provide high reactivity in catalysis and a large storage site for the target material (for non-limiting example, a site sufficient for hydrogen adsorption).

In an embodiment of the present disclosure, the nanoparticle may be located at a (6,6)-edge, a (5,4)-edge, a (9.6)-edge, a (6,5)-edge, a (9,4)-edge, or a (6,4)-edge of the amorphous isotropic carbon compound. The nanoparticle may be located at the edge generated in the carbon defect. For example, the (6,6)-edge may be referred to as an edge made by two faces of 6-membered rings generated by a carbon defect.

In an embodiment of the present disclosure, the amorphous catalyst composite may be used for hydrogen adsorption and desorption, hydrogen evolution reaction (HER), oxygen reduction reaction (ORR), oxygen evolution reaction (OER), hydrogen oxidation reaction (HOR), photocatalyst or carbon dioxide reduction reaction, but may not be limited thereto. Specifically, a catalyst to be reacted may be selected from various catalysts depending on the kind of the nanoparticle. For example, an atomic Pt nanoparticle which is present at the carbon defect of the amorphous isotropic carbon compound facilitates not only adsorption of a large amount of hydrogen and but also easy desorption of hydrogen. The atomic nanoparticle can serve as an active catalyst for adsorption of hydrogen molecules, split the hydrogen molecules, and allow dissociated hydrogen atoms to move (diffuse) to areas other than the carbon defect of the amorphous isotropic carbon compound (H₂-spillover). The hydrogen atoms moving to the areas other than the carbon defects may be stably adsorbed on the surface of the amorphous isotropic carbon compound.

In an embodiment of the present disclosure, the amorphous isotropic carbon compound may include a micropore, a mesopore, or both of them on the surface. Specifically, before the nanoparticle is bound to the amorphous isotropic carbon compound, the amorphous isotropic carbon compound may have a higher cumulative pore volume than a crystalline isotropic carbon compound since it includes the micropore, the mesopore, or both of them on the surface. The micropore and the mesopore may provide a high specific surface area and also provide a high reactivity in catalysis and a large storage site for the target material (for non-limiting example, a site sufficient for hydrogen adsorption).

In an embodiment of the present disclosure, a diameter of the micropore may be about 2 nm or less, about 0.1 nm to about 2 nm, about 0.5 nm to about 2 nm, or about 1 nm to about 2 nm, but may not be limited thereto. In an embodiment of the present disclosure, a diameter of the mesopore may be about 2 nm to about 50 nm, about 2 nm to about 40 nm, about 2 nm to about 30 nm, about 2 nm to about 20 nm, about 2 nm to about 10 nm, about 2 nm to about 8 nm, about 2 nm to about 6 nm, about 3 nm to about 50 nm, about 3 nm to about 40 nm, about 3 nm to about 30 nm, about 3 nm to about 20 nm, about 3 nm to about 10 nm, about 3 nm to about 8 nm, about 3 nm to about 6 nm, about 4 nm to about 50 nm, about 4 nm to about 40 nm, about 4 nm to about 30 nm, about 4 nm to about 20 nm, about 4 nm to about 10 nm, about 4 nm to about 8 nm, or about 4 nm to about 6 nm, but may not be limited thereto. Herein, the micropore has a smaller diameter than the mesopore.

For non-limiting example, the amorphous isotropic carbon compound may be C₆₀ fullerene having a hollow sphere shape with a carbon defect, and the nanoparticle may be atomic scale Pt, and the amorphous catalyst composite may be used for physical hydrogen adsorption and desorption. In this case, the amount of hydrogen adsorbed by the amorphous catalyst composite may reach 6 wt % at room temperature and 90 bar pressure. Also, the amorphous catalyst composite can have stability even after several cycles of use and thus can be used as a hydrogen storage medium.

A second aspect of the present disclosure provides a method of preparing an amorphous catalyst composite, including a process of dispersing a crystalline isotropic carbon compound in an alkaline solution; a process of obtaining and calcining the dispersed material to obtain an amorphous isotropic carbon compound with a carbon defect; and a process of impregnating the obtained amorphous isotropic carbon compound in a solution containing a nanoparticle precursor.

Specifically, the amorphous catalyst composite of the present disclosure may be prepared through a series of processes including 1) a process of preparing the amorphous isotropic carbon compound with the carbon defect through basic activation of the crystalline isotropic carbon compound (for non-limiting example, KOH activation) and 2) a process of introducing an atomic nanoparticle into the carbon defect. That is, the crystalline isotropic carbon compound in a room temperature state may be present as a dimer, and may have a face centered cubic structure (FCC). In the present disclosure, an amorphous catalyst composite may be prepared by converting the crystalline isotropic carbon compound into an amorphous isotropic carbon compound with carbon defect through basic activation and stabilizing the atomic nanoparticle with the carbon defect.

Detailed descriptions on the second aspect of the present disclosure, which overlap with those on the first aspect of the present disclosure, are omitted hereinafter, but the descriptions of the first aspect of the present disclosure may be identically applied to the second aspect of the present disclosure, even though they are omitted hereinafter.

In an embodiment of the present disclosure, a concentration of the alkaline solution may be about 0.01 M to about 0.08 M. Also, the concentration of the alkaline solution may be about 0.01 M to about 0.07 M, about 0.01 M to about 0.06 M, about 0.02 M to about 0.07 M, or about 0.02 M to about 0.06 M. The concentration of the alkaline solution is very important for producing an amorphous isotropic carbon compound with an appropriate level of a carbon defect. If the concentration of the alkaline solution is lower than about 0.01 M, the crystallinity of the crystalline isotropic carbon compound may not be completely resolved and no carbon defect may be generated.

However, if the concentration of the alkaline solution is higher than about 0.08 M, the formation of an amorphous phase may be accelerated and the carbon compound may be torn instead of having a carbon defect, and, thus, a layered carbon compound may be produced.

In an embodiment of the present disclosure, the alkaline solution may include KOH, but may not be limited thereto.

In an embodiment of the present disclosure, the process of dispersing the crystalline isotropic carbon compound in the alkaline solution may be performed at about 273 K to about 310 K.

In an embodiment of the present disclosure, the process of dispersing the crystalline isotropic carbon compound in the alkaline solution may be performed at about 273 K to about 310 K or about 273 K to about 300 K.

Hereinafter, example embodiments are described in more detail by using Examples, but the present disclosure may not limited to the Examples.

### Example

### Example. Preparation of an Amorphous Catalyst Composite

### 1. Preparation and Structural Characterizations of Amorphous C₆₀₋ₓ Fullerene

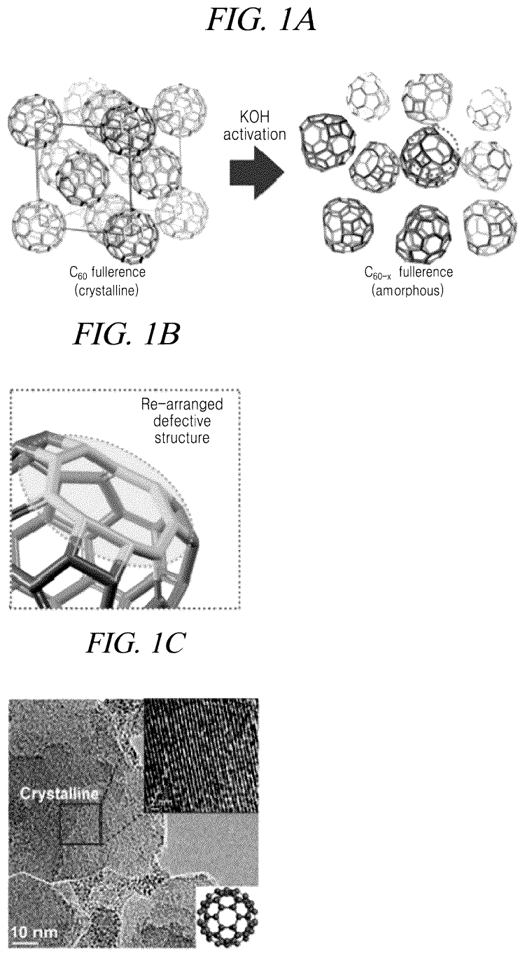

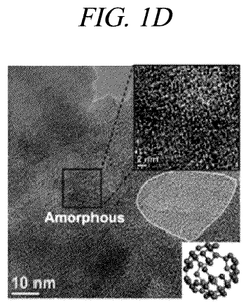

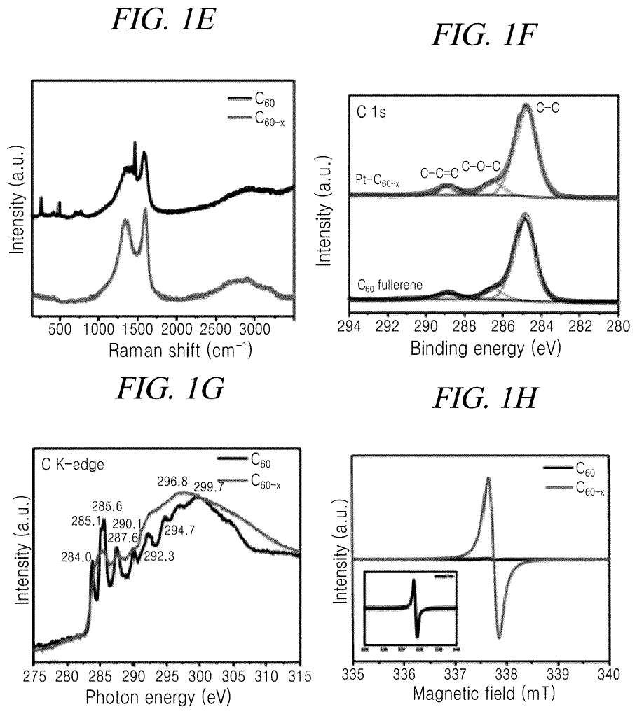

For synthesizing amorphous C₆₀₋ₓ fullerene, KOH activation was conducted. 400 mg of C₆₀ fullerene was ultrasonically dispersed in 40 MI of 0.05 M KOH solution for 12 hours, maintaining the temperature at 275 K with water-jacket system. As-prepared C₆₀ fullerene solution was centrifuged and dried in vacuum oven. Dried powder was collected and suffered the calcination step in rapid thermal chemical vapor deposition (RT-CVD) system; 1073 K for 2 hours, under Ar atmosphere. Resulting C₆₀₋ₓ fullerene was rinsed with DI and ethanol to remove residual KOH or other ions. Finally, A C₆₀ fullerene with a disordered amorphous structure and carbon defects was obtained (FIG. 1A).

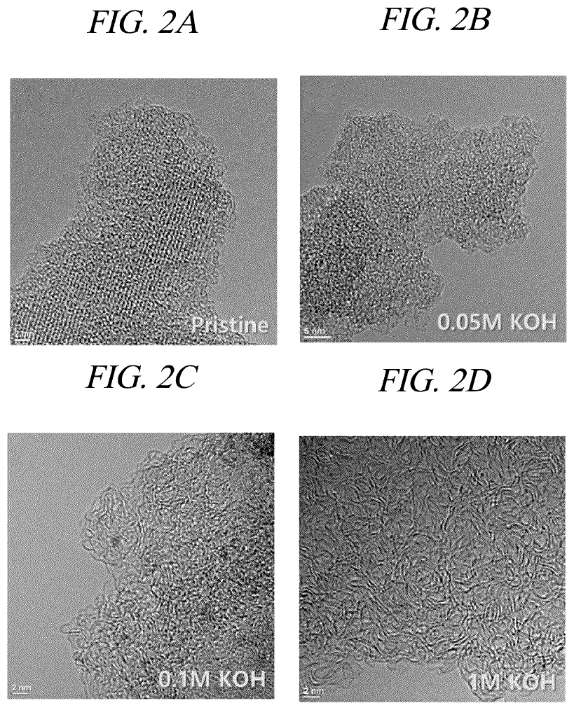

FIG. 1B describes the re-arranged defective structure with a hole. The transmission electron microscopy (TEM) images of pristine C₆₀ fullerene (FIG. 1C) showed a clear lattice fringes because the pristine C₆₀ fullerene has the FCC structure. Also, FIG. 1D showed the as-synthesized defective fullerene (C₆₀₋ₓ) TEM image. The lattice fringe which appears in crystalline C₆₀ fullerene disappeared and an amorphous structure without sheet-shaped carbon was observed in the TEM image of FIG. 1D. Appropriate activation condition induced crystalline C₆₀ structure to simple amorphous carbon structure, which means spherical fullerene structure was partially collapsed with hole. Meanwhile, it was observed that the C₆₀ structure changed depending on the concentration of KOH (FIGS. 2A to 2D). In the low KOH concentration activation process, not only the FCC structure lattice fringe of fullerene was observed, but also the aggregated carbon particles based on spherical shaped fullerenes were observed. In the high KOH concentration activation process, lattice fringes of FCC structure disappeared and the sheet-shaped carbon composites were observed. This result can be interpreted that the carbon bonds that make up the spherical fullerene are gradually broken through KOH activation causing dented spherical structure transformation, and when more carbon bonds are broken, the spherical structure changed to a simple graphitic carbon. Based on KOH concentration variation result, in order to form a structure suitable for hydrogen diffusion, KOH concentration conditions were controlled in which hole can be formed while maintaining the spherical shape.

The Raman spectra (FIG. 1E) revealed the C₆₀ fullerene structure change from KOH activation process. The distinct peaks of C₆₀ samples at 499 cm⁻¹ and 1471 cm⁻¹ are determined to the symmetrical radial breathing motion of the carbon atoms (A_{g}(1)) and the pentagonal pinch mode (A_{g}(2)) of C₆₀ fullerene, respectively. The distributed small peaks between 274 cm⁻¹ and 1469 cm⁻¹ are also attributed to H_{g} mode of C₆₀ fullerene. After KOH activation process, these characteristic C₆₀ fullerene peaks were disappeared and only the broad D band (1350 cm⁻¹) and G band (1590 cm⁻¹) are remained in C₆₀₋ₓ samples. This indicates that carbon defects generated during the activation process lead to the relaxation of vibrational mode in fullerene by forming the distorted C₆₀₋ₓ fullerene structure.

Meanwhile, the increased ratio of I_{D}/I_{G} supported that the disordered carbon structure and intrinsic carbon defects were formed in C₆₀₋ₓ. This result demonstrated that the structure of the C₆₀ fullerene was damaged by KOH and formed disordered defects which have the capability to facilitate the hydrogen diffusion into the inside of C₆₀₋ₓ fullerene.

The C 1s XPS spectrum of the C₆₀₋ₓ and C₆₀ fullerene are shown in FIG. 1F. In this C 1s XPS spectrum, the three were observed at 285 Ev, 286.5 ev, and 288.4 Ev in both samples, which can be interpreted as the presence of C—C, C—O—C, and C—C═O bonds, respectively (FIG. 1F). Since C 1s XPS spectrum is not sufficient to elucidate the exact chemical state of carbon in C₆₀₋ₓ fullerene, a more detailed change in carbon structure was investigated through the carbon K-edge near-edge X-ray absorption fine structure (NEXAFS) spectra (FIG. 1G). The C₆₀ fullerene NEXAFS spectra showed the intense peaks in the low energy range (284 Ev to 288 Ev) attributed to the transitions of C 1s core-level electrons to π* states. Meanwhile, the C₆₀₋ₓ NEXAFS spectra revealed that characteristic peaks of C₆₀ fullerene in the low energy level disappeared and a low intensity broad peak was formed in π* state region. While 284 Ev distinct peak corresponding to C₆₀ fullerene dimer in crystalline structure was observed in C₆₀ fullerene sample, the dimer related peak was disappeared in C₆₀₋ₓ sample. This peaks pattern change can be interpreted that KOH activation provided the more disordered carbon structure with defects.

The presence of defects in carbon can also be demonstrated through electron spin resonance (ESR) spectroscopy (FIG. 1H). A strong signal of C₆₀₋ₓ was observed in the 337 Mt to 338 Mt region, whereas a feeble signal was observed in C₆₀ fullerene. The observed ESR signal in defective C₆₀₋ₓ is attributed to either paramagnetic carbon related dangling bond or other structural defects. Since the intensity in ESR spectrum is directly proportional to the concentration of unpaired electrons, the result of ESR indicate that KOH activation process transformed typical delocalized C₆₀ fullerene carbon bond to disordered and localized electron stated carbon dangling bond.

### 2. Preparation and Structural Characterizations of C₆₀₋ₓ Fullerene

For introducing atomic scale of Pt metal on amorphous C₆₀₋ₓ fullerene, wet impregnation method that add C₆₀₋ₓ samples into the Pt precursor solution was adapted. First, 10 mg of C₆₀₋ₓ fullerene was dispersed in chloroplatinic acid solution (H₂PtCl₆·Xh₂O 1 mg in 2 MI deionized water). Put the solution into 25 MI round flask and stir vigorously for 6 hours under 333K. After wet impregnation, the powder was collected by centrifuging and dried in vacuum oven. Resulting Pt—C₆₀₋ₓ suffered the heat treatment step in RT-CVD system; 398 K for 1 hours, under Ar atmosphere.

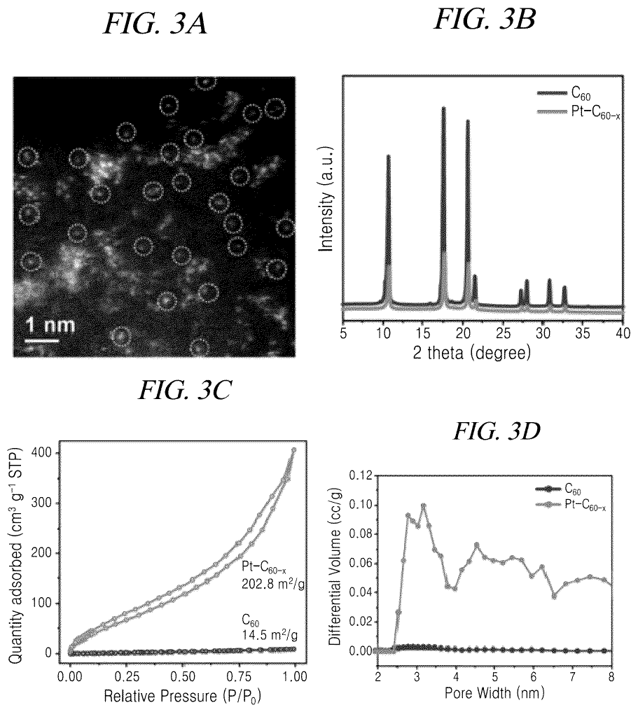

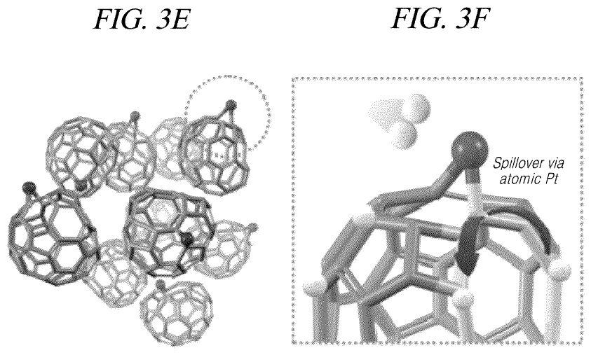

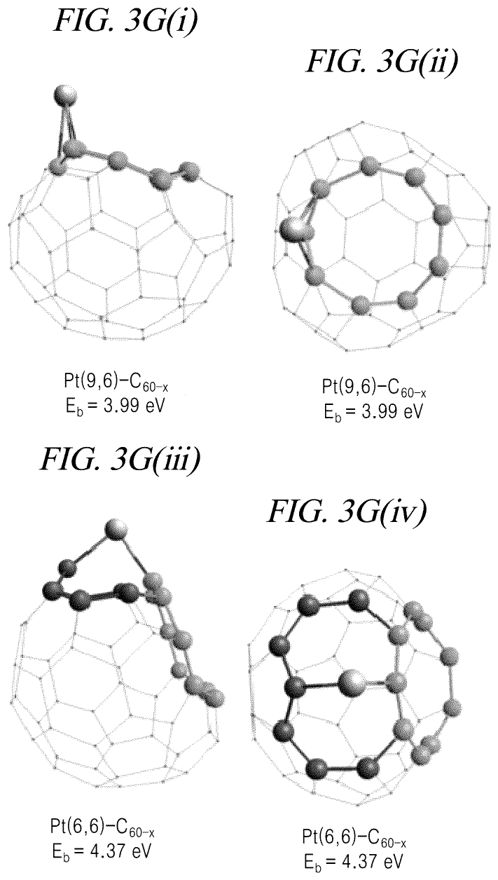

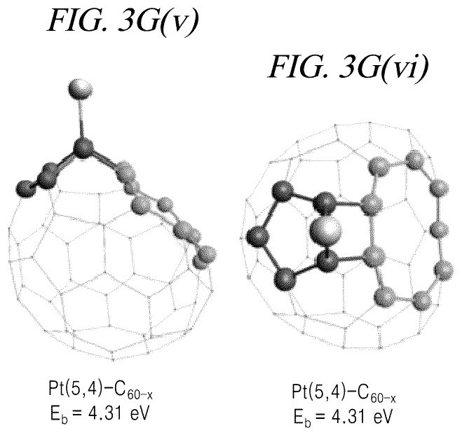

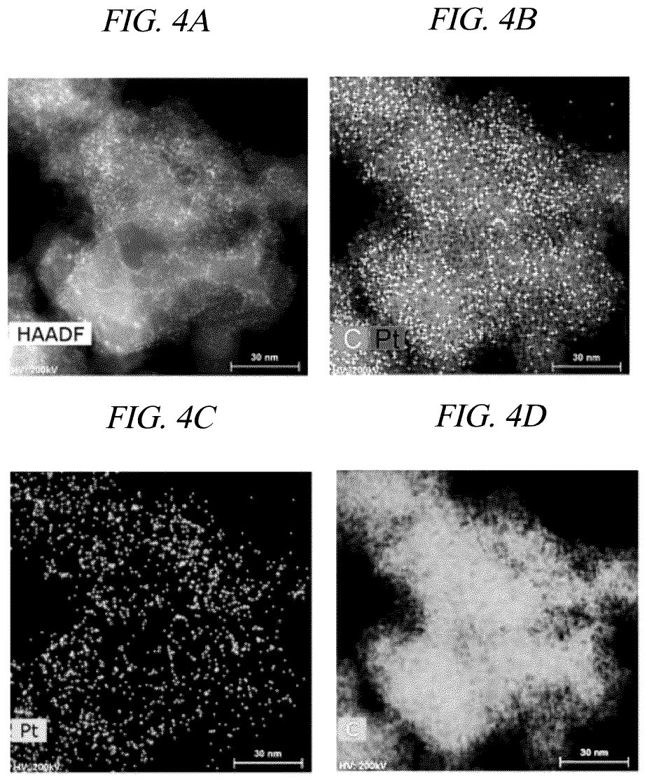

The high-angle annular dark field-scanning transmission electron microscopy (HAADF-STEM) image of as-synthesized Pt—C₆₀₋ₓ is shown in FIG. 3A. The brighter dots in the images demonstrated the strong diffraction from the heavy Pt atoms, while the less bright dots indicated the weak diffractions from the lighter C atoms of C₆₀₋ₓ support. We observed a uniform and molecular cluster sized bright signal from Pt—C₆₀₋ₓ, indicating that atomic-sized Pt clusters were uniformly distributed and linked to the C₆₀₋ₓ support. The energy dispersive X-ray spectroscopy (EDS) (FIGS. 4A to 4D) also showed that Pt elements were evenly distributed in the C₆₀₋ₓ support.

The X-ray diffraction (XRD) patterns of C₆₀ fullerene and Pt—C₆₀₋ₓ were shown in FIG. 3B. While the C₆₀ fullerene XRD pattern exhibited representative peaks of crystalline structure corresponding to (111), (220), (311), (420), and (422) planes were observed, Pt—C₆₀₋ₓ sample XRD pattern revealed the diminished intensity of crystalline peaks compared to that of crystalline C₆₀ fullerene. In addition, the crystallinity concerned with Pt phase did not occur at all because the existing Pt phase on amorphous C₆₀₋ₓ fullerene are atomically dispersed on the surface of carbon substrate.

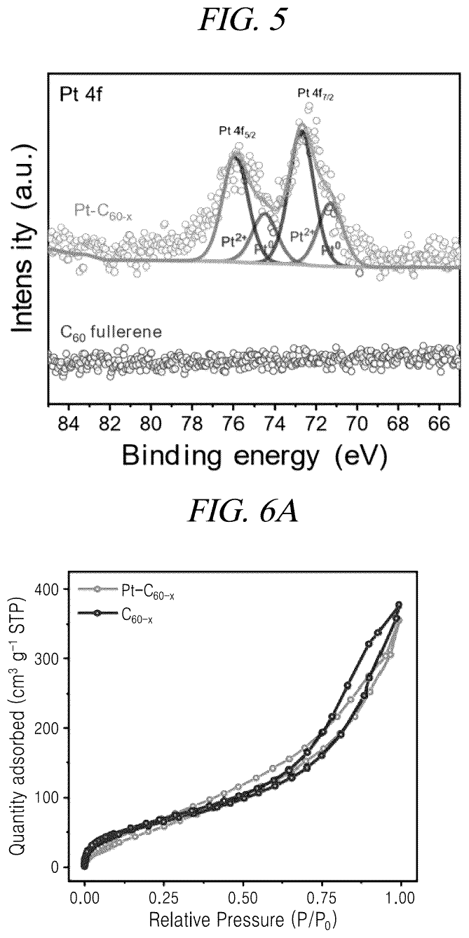

The chemical state of elements can be confirmed through the X-ray photoelectron spectroscopy (XPS) spectra of Pt—C₆₀₋ₓ and C₆₀ fullerene (FIG. 5). The Pt 4f XPS spectrum of the Pt—C₆₀₋ₓ sample could be deconvoluted into two different peaks. The peaks at 75.9 Ev and 72.7 Ev are ascribed to the Pt²⁺ oxidation state, at 74.8 Ev and 71.2 Ev are attributed to Pt⁰, respectively. Compared with Pt⁰ state, the Pt²⁺ oxidized state has a higher intensity. It can be interpreted that the dispersed Pt atoms of Pt—C₆₀₋ₓ have form of atomic cluster with oxidized surface. These atomic Pt clusters provides the advantage of more efficient adsorption of hydrogen molecules due to the enlarged reaction active site.

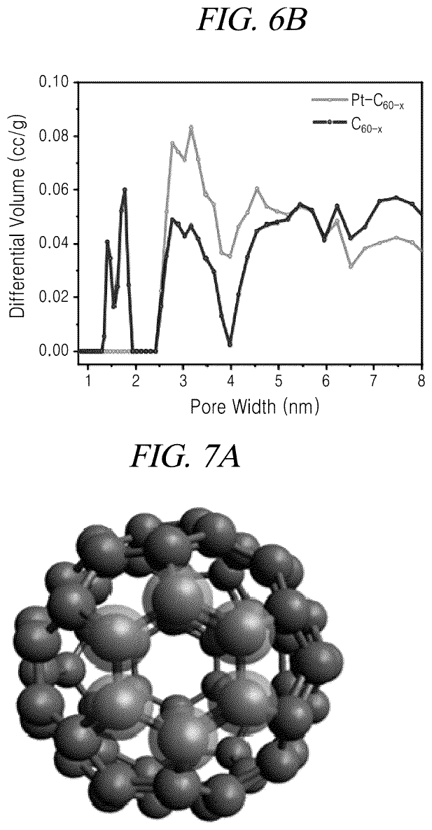

To further investigate the effects of structure change of KOH activation and introducing Pt step, we examined the nitrogen adsorption-desorption analysis for measuring the change of surface area and existence of pore after KOH activation. FIG. 3C shows the nitrogen adsorption-desorption isotherm curve of C₆₀ and Pt—C₆₀₋ₓ. The measured Brunauer-Emmett-Teller (BET) surface area of C₆₀₋ₓ (202.8 m²g⁻¹) was demonstrated to be about 14-fold higher than that of C₆₀ (14.5 m²g⁻¹). Besides, FIG. 3D shows that Pt—C₆₀₋ₓ has rich micropores and mesopores in 2.5 nm to 25 nm region leading to a high cumulative pore volume of 0.416 cm³g⁻¹. On the contrary, C₆₀ fullerene has a low cumulative pore volume value of 0.021 cm³g⁻¹. The increased surface area and pore formation in Pt—C₆₀₋ₓ via KOH activation can be interpreted as providing abundant sites for hydrogen adsorption on surface. Although the introducing Pt induces the possibility for passivation of active surface area in C₆₀₋ₓ, it is shown that the surface area for hydrogen adsorption was preserved after the Pt anchoring process (FIG. 6A). Pore distribution curve of C₆₀₋ₓ and Pt—C₆₀₋ₓ are shown in FIG. 6B. The 1 nm to 2 nm region micropores were observed in C₆₀₋ₓ sample, but micropores of this region were disappear in pore distribution curve of Pt—C₆₀₋ₓ sample. This result can be interpreted that the defective sites of C₆₀₋ₓ were mainly filled with atomic Pt cluster.

Based on structure characterization, the schematic illustration in FIGS. 3E and 3F shows the atomic Pt-anchored C₆₀₋ₓ fullerene and the expected atomic Pt-mediated hydrogen adsorption via hydrogen spillover. At first, a hydrogen molecule approaches to the atomic Pt and composes the chemical bond with Pt. And then, exposed Pt ensures the cleavage of H—H bond and facilitates the diffusion of dissociated hydrogen atoms onto carbon substrate.

To theoretically investigate the performance of the atomic Pt-doped defective fullerene for hydrogen storage, the density functional theory (DFT) with Perdew-Burke-Ernzerhof exchange-correlation functionals equipped in Vienna Ab initio Simulation Package (VASP) was applied to measure the energetics of the hydrogen storage pathway. The cutoff energy of 450 Ev was used with kpoints of gamma.

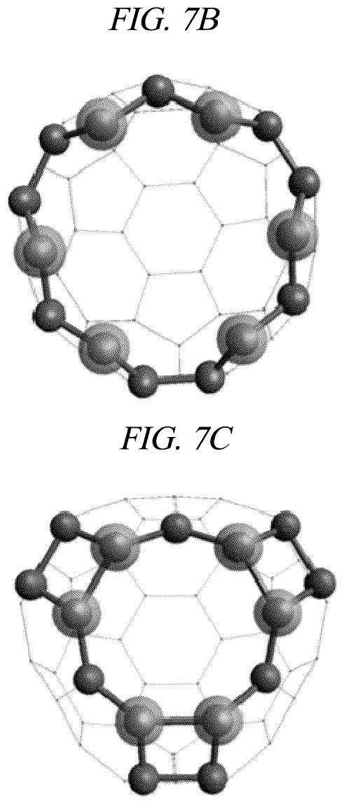

Based on the experimental analysis, the model could be made by extracting C atoms about 10% from C₆₀ and one Pt atom is doped on the defective C₆₀₋ₓ. The selected model of defect C₅₄ was made by removing 6 atoms of benzene ring to have a nanohole of 5.1 Å as shown in FIG. 7A. Then the effect of defect on Pt-doping and H₂-spillover mechanism was estimated systematically. The nanohole of the defect is reconstructed during the optimization process which results in removing all the dangling bonds of 6 C atoms and making 4-membered rings. Then the size of nanohole reduces to 4.2 Å and the defect region is reconstructed into the 9-membered ring as shown in FIGS. 7B and 7C.

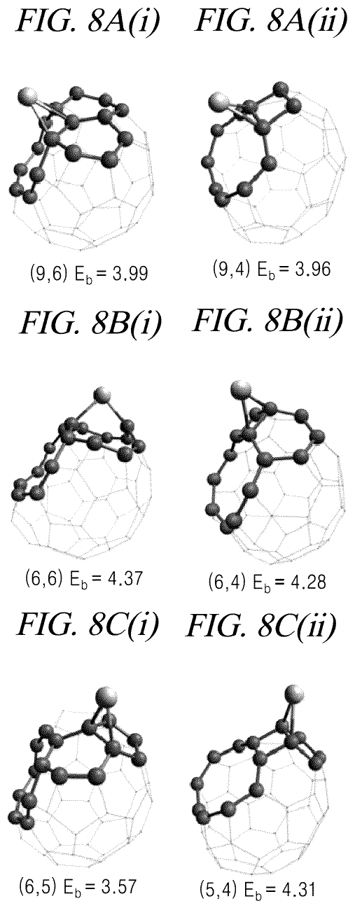

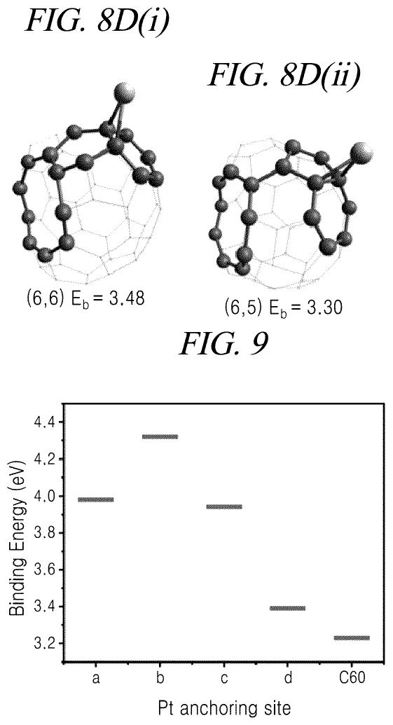

The Pt atom was tested to be doped at all the possible sites around defect region as shown in FIGS. 8A(i), 8A(ii), 8B(i), 8B(ii), 8C(i), 8C(ii), 8D(i), and 8D(ii). The binding energy of Pt atom (E_{b}) is calculated by the following Equation 1:

$${E}_{b} = ( {E}_{C 54} + {E}_{P t ( g )} ) - {E}_{P t - C 54} \qquad [ Equation 1 ]$$

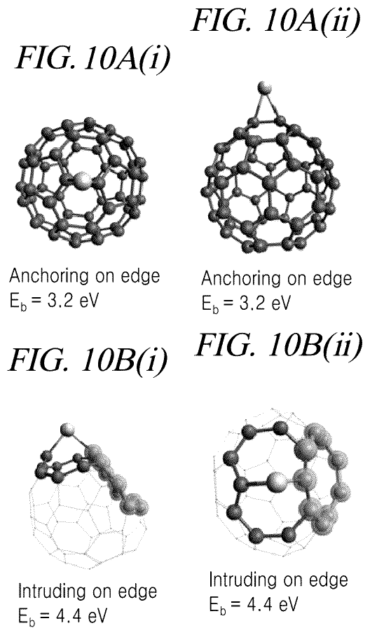

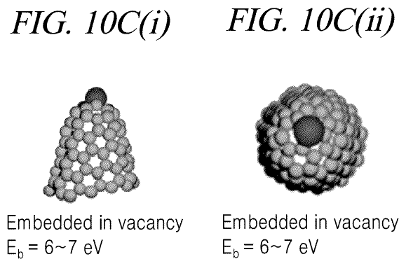

Pt atom is stabilized on the edge site between two polygonal faces and the binding energy (BE) becomes maximized around the defect area then it decreases to that of the pristine C₆₀ as the anchoring site moves to the intact area as shown in FIG. 9. As a result, Pt will be doped around the defect region. Among the possible locations, (6,6)-edge next to defect region in FIGS. 3G(i) to 3G(vi) and FIG. 8B(i) has the highest BE where Pt intrudes the C—C bond making a 7-membered ring, where (n,m)-edge is referred to as the edge made by two faces of n- and m-membered rings. The BE of Pt in the intruding model is about 4.4 Ev, which is more stabilized than 3.2 Ev of the simple anchoring model of Pt on the pristine C₆₀, but much smaller than 7 Ev of the imbedded model in a vacancy site where Pt binds to the dangling C's as shown in FIGS. 10 A(i), 10A(ii), 10B(i), 10B(ii), 10C(i), and 10C(ii).

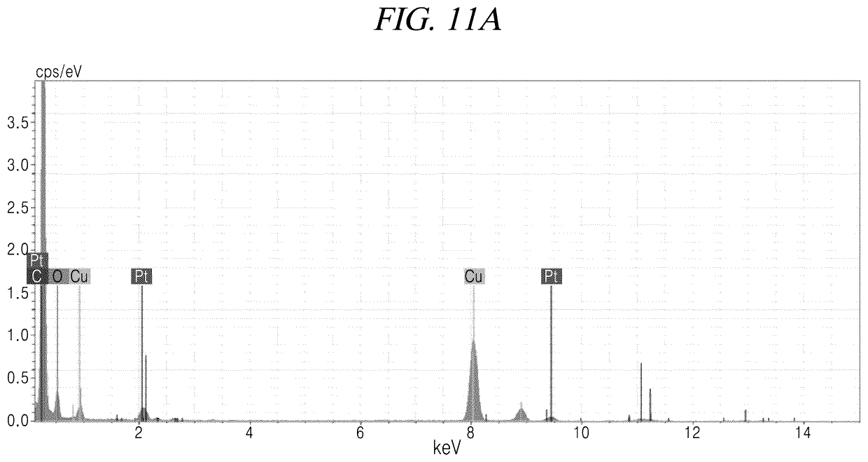

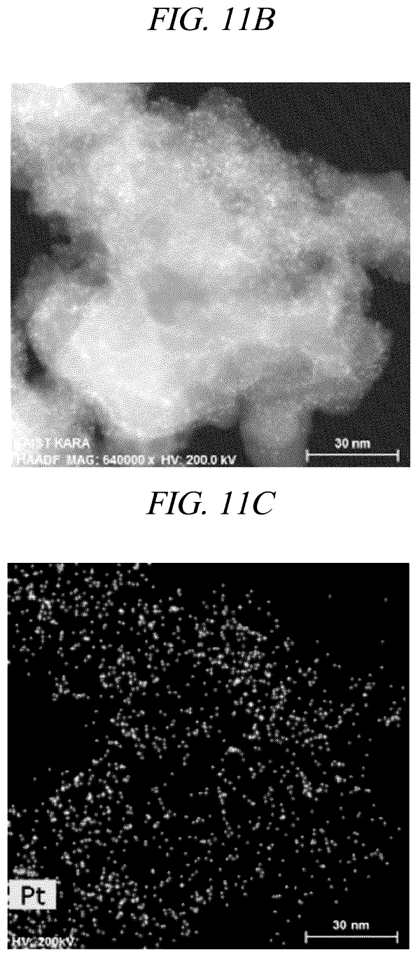

Also, we analyzed Pt loading ratio on Pt—C₆₀₋ₓ through the energy dispersive spectroscopy (EDS) mapping analysis of Pt—C₆₀₋ₓ (FIGS. 11A to 11C and Table 1). Referring to FIGS. 11 A to 11C and the following Table 1, the content of Pt in Pt—C₆₀₋ₓ is about 0.259 at. % (atomic percent)(about 4.055 wt. %). Pt—C₆₀₋ₓ according to an example of the present disclosure is capable of high-capacity hydrogen storage despite a very small content of Pt which is a noble metal.

TABLE 1

| | | | | [norm. | [norm. |
|---|---|---|---|---|---|
| Element | Series | Net | [wt. %] | wt. %] | at. %] |
| Carbon | K-series | 70284 | 95.94432 | 95.94431851 | 99.74041347 |
| Plati- | L-series | 2864 | 4.055681 | 4.055681492 | 0.259586526 |
| num | | | | | |

### Experimental Example 1. Confirmation of Hydrogen Storage of Pt—C₆₀₋ₓ

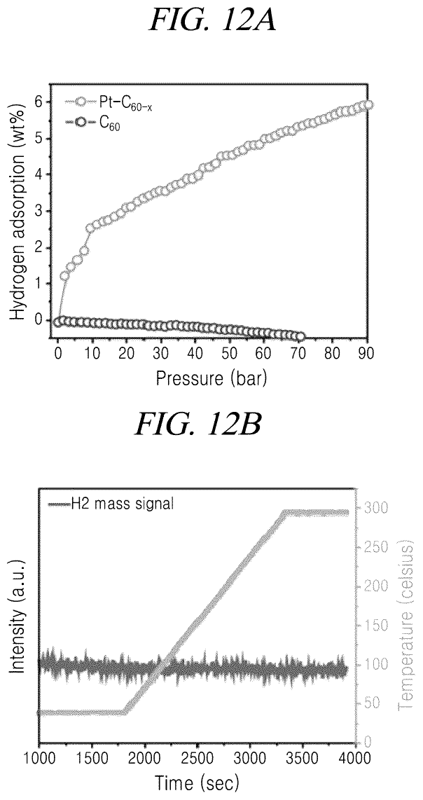

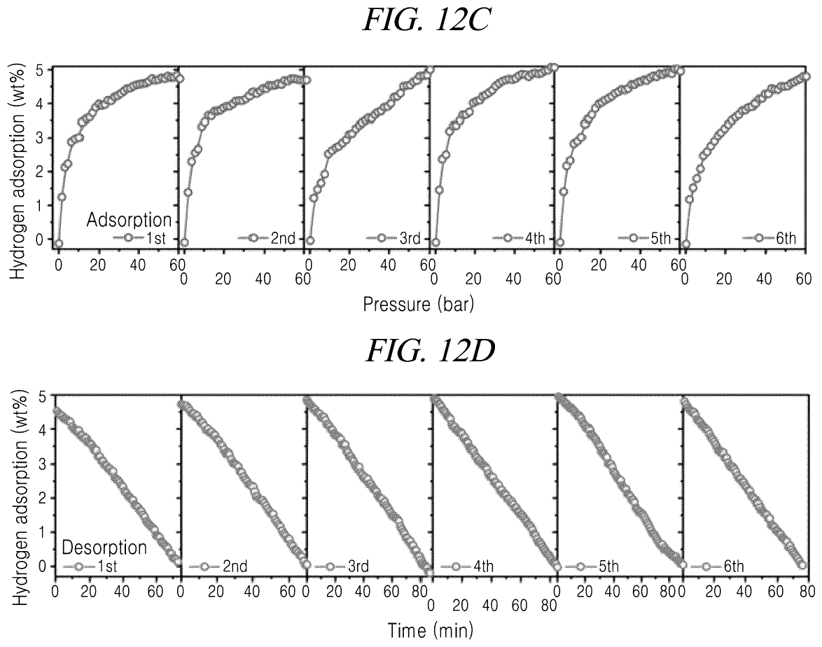

The hydrogen adsorption isotherm curve of Pt—C₆₀₋ₓ and C₆₀ fullerene measured at room temperature is shown in FIG. 12A. It was observed that hydrogen absorption of Pt—C₆₀₋ₓ amounted to 6 wt % at 90 bar, which is superior to that of the C₆₀ fullerene under identical room temperature conditions. To further investigate the hydrogen adsorption reaction mechanism of the Pt—C₆₀₋ₓ, temperature programmed desorption (TPD) measurements were conducted at a rate of 10° C./min from ambient room temperature to 300° C. (FIG. 12B). TPD analysis exhibited that the signal of H₂ did not detected according to the temperature increasing. It is demonstrated that H₂ adsorption reaction of Pt—C₆₀₋ₓ did not proceed through the chemisorption reaction.

The several hydrogen adsorption (FIG. 12C) and desorption (FIG. 12D) cycles of Pt—C₆₀₋ₓ collected at room temperature and range of 0.1 bar to 60 bar. As a result, the hydrogen adsorption capacity of Pt—C₆₀₋ₓ maintained up to 4.6 wt % to 5.0 wt % during six times operations. During the hydrogen desorption process, the most of the absorbed H₂ gradually released the residual hydrogen within 30 min at ambient room temperature by 0.5 bar. A repeating hydrogen storage performance demonstrates the reproducibility of Pt—C₆₀₋ₓ with reversible hydrogen adsorption/desorption.

### Experimental Example 2. Confirmation of H₂-Spillover Reaction Path

The energetics of H₂ adsorption and H atom migration were examined for the three models in FIGS. 3G(i) to 3G(vi), where the Pt anchoring site is on the defect region in Pt(9,6)—C₆₀₋ₓ, the connected edge to the defect edge in Pt(6,6)—C₆₀₋ₓ, and the one edge apart from the defect edge in Pt(5,4)—C₆₀₋ₓ, respectively. In these models, Pt can bind only two additional H₂ molecules while it anchors on two C atoms on the edge of the defect fullerene.

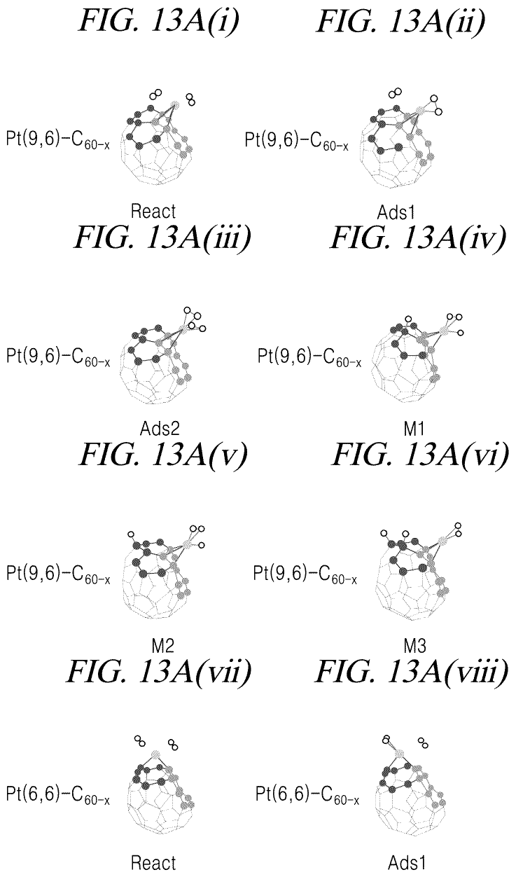

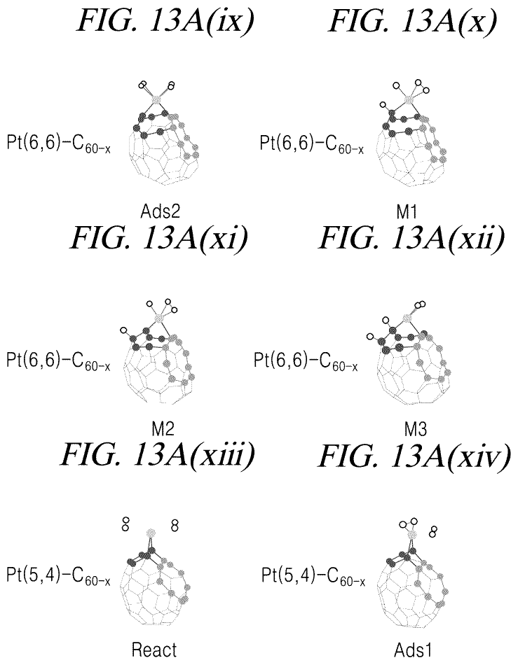

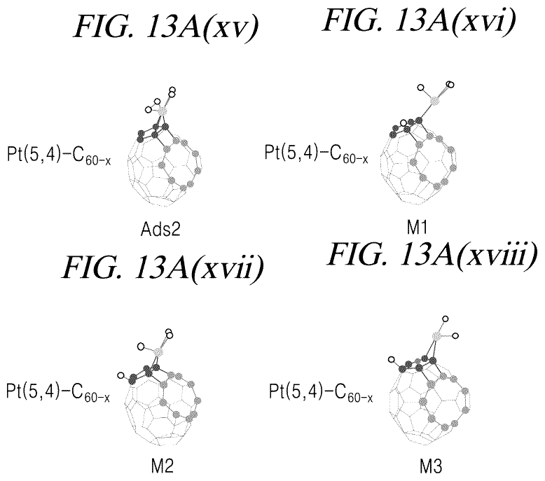

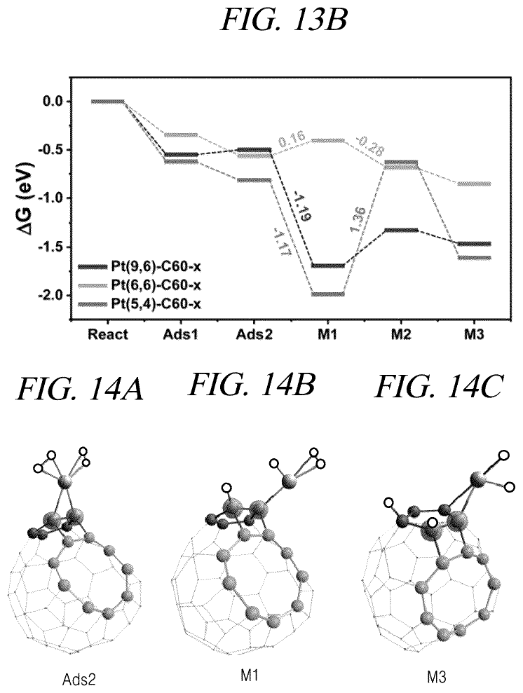

The optimized structures following the H migration paths of the three models were examined as shown in FIGS. 13A(i) to 13A(x viii) and FIGS. 7A to 7C. The adsorption enthalpy of each state was calculated with reference to reactants by Equation 2 and 4 (where E includes the zero-point energy of hydrogen and A(PV) is only applied to H₂ adsorption step for gas state):

$$Δ H = Δ E + Δ ( PV ) \qquad [ Equation 2 ]$$

$$Δ E = {E}_{n H / P t - {C}_{60 - x}} - \{ {E}_{P t - {C}_{60 - x}} + \frac{1}{2} {nE}_{{H}_{2} ( g )} \} \qquad [ Equation 4 ]$$

Among proposed models, Pt(5,4)—C₆₀₋ₓ, where Pt is doped further away from defect region, Pt stands on the edge of (5,4)-edge. As shown in FIGS. 14A to 14C, when H atom migrates to the one of the supporting C, the bond of C—Pt is completely disconnected as the supporting C's make the stable tetrahedral structure of sp³ for both H and H₃—Pt. Furthermore, Pt can be moved to another edge in the following H migration step. Therefore, the simple standing model of Pt near the defect region is very unstable.

The energy profile following the H₂-spillover reaction for Pt(9,6)—C₆₀₋ₓ and Pt(6,6)—C₆₀₋ₓ are drawn in FIG. 13B, where Ads stands for the adsorption of H₂ molecule on Pt and M denotes the migration of H atom. In both models, H₂ molecules adsorbed on Pt barrierlessly. In the case of Pt(9,6)—C₆₀₋ₓ, Pt anchors on 3C's where one bond length is about 0.130 Å longer than the others of 2.067 Å. The 1^{st} migration step is largely stabilized by −1.25 Ev, and this will induce a large endothermic reaction in the successive reaction and also it will act adversely in the reverse reaction of the recovery of H₂. The ideal model should have the equally distributed elementary steps with respect to the reactants of Pt—C₆₀₋ₓ and H₂ gases and the product of the fully H-doped Pt—C₆₀₋ₓ. In Pt(6,6)—C₆₀₋ₓ, Pt intrudes into C—C bonds of (6,6)-edge next to the defect region, making 7-membered ring on both sides. Note that 6-membered ring is not planar, which means C—C bond is very weak also. The distorted benzene ring comes from the strong reconstruction reaction between the dangling carbons in the optimization process. Then Pt can intrude into weak C—C bonds next to the defect region. And the angle of C—Pt—C of Pt(6,6)—C₆₀₋ₓ is almost right angle with 87.4°, which is ideal to make a square planar structure with two H₂ molecules. Then the first two H₂-adsorption enthalpies are almost equally distributed as −0.72 Ev and −0.58 Ev, comparing with those of −0.90 Ev and −0.27 Ev in Pt(9,6)—C₆₀₋ₓ. And the following H-migration reaction in Pt(6,6)—C₆₀₋ₓ shows 0.13 Ev barrier in H₂-spillover process and 0.27 Ev barrier for H₂-release process. Then in the overall processes, H₂ adsorption reaction step appears to be the rate determining step at reverse reaction.

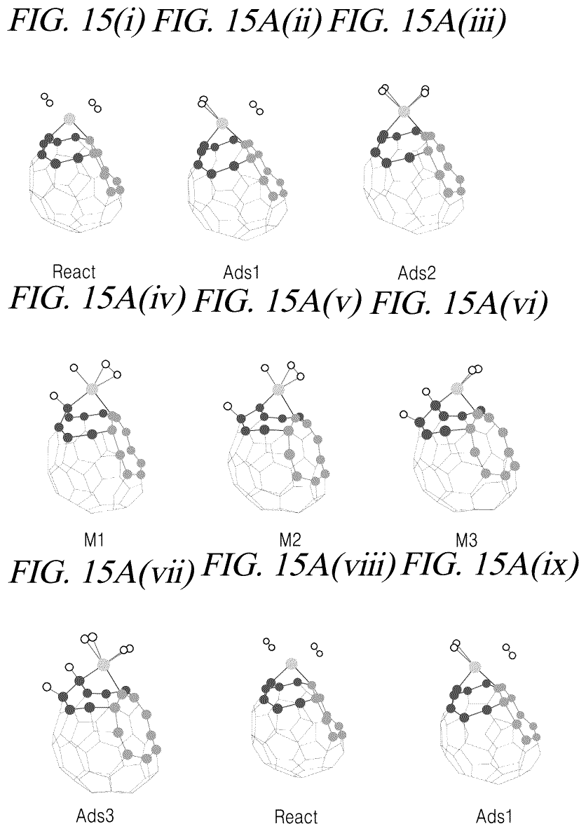

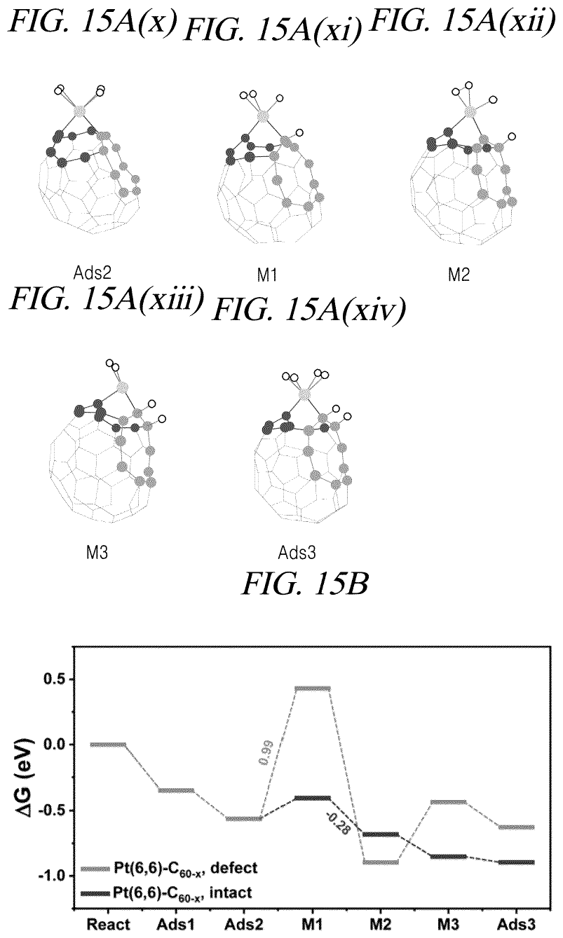

As for the direction of H₂-spillover phenomena, two pathways towards the intact and the defect regions are compared for Pt(6,6)—C₆₀₋ₓ in FIGS. 15 A(i) to 15A(x iv) and 15B. The diffusion to the intact region is more feasible than that to the defect region which shows large barrier in the first H-migration step. Therefore, the H₂-spillover reaction is expected to occur towards the intact region through the activation at Pt-doped defect C₆₀₋ₓ.

In conclusion, Pt—C₆₀₋ₓ of an example of the present disclosure was synthesized through KOH activation and Pt introduction process. As-synthesized Pt—C₆₀₋ₓ has amorphous structure with carbon defects resulting from the cleavage of crystalline C₆₀ fullerene dimer. The changes in structure was verified by XRD, Raman spectroscopy, NEXAFS, ESR, N₂ isotherm adsorption/desorption analysis. The resulting amorphous C₆₀₋ₓ fullerene has enlarged surface area which provides extended amount of adsorbed hydrogen and carbon defects in C₆₀₋ₓ fullerene contribute the facile access of hydrogen molecules by lowering the activation energies of hydrogen adsorption and desorption. Attached Pt in atomic-scale boosted the pseudo-physically adsorption of hydrogen through the hydrogen spillover on the ambient room temperature. A gravimetric hydrogen storage capacity was achieved up to 6.0 wt % under 60 bar pressure, which is superior to that of pristine C₆₀ fullerene. Moreover, the desorption of adsorbed hydrogen was feasible, confirmed by the repeated adsorption and desorption experiments. Through the DFT calculation, Pt is preferable doped near the defect region and it become most stabilized when it intrudes the weakened C—C bond, which is ascribed to the twisted 6-membered ring due to the strong defect reconstruction of the dangling carbons. Furthermore, this model shows very equally distributed energies in the elementary steps of H₂ adsorption and H-migration. We expect our hydrogen storage strategy will be applicable to a wide range of nanomaterials, providing a breakthrough to realize high-performance hydrogen storage.

It would be understood by a person with ordinary skill in the art that various changes and modifications may be made based on the above description without changing technical conception and essential features of the present disclosure. Thus, it is clear that the above-described embodiments are illustrative in all aspects and do not limit the present disclosure.

The scope of the present disclosure is defined by the following claims. It shall be understood that all modifications and embodiments conceived from the meaning and scope of the claims and their equivalents are included in the scope of the present disclosure.

We claim:

1. An amorphous catalyst composite, comprising
an amorphous isotropic carbon compound with a carbon defect; and
a nanoparticle located at the carbon defect.

2. The composite of claim 1,
wherein the amorphous isotropic carbon compound includes a homogeneous carbon compound having a hollow sphere shape, an ellipsoid shape, or a tube shape.

3. The composite of claim 2,
wherein the homogeneous carbon compound having the hollow sphere shape includes at least one selected from C₆₀ fullerene, C₇₀ fullerene, C₇₂ fullerene, C₇₆ fullerene, C₈₄ fullerene, and C₁₁₀ fullerene.

4. The composite of claim 1,
wherein the nanoparticle is atomic scale.

5. The composite of claim 1,
wherein the nanoparticle includes at least one selected from Pt, Fe, Ni, Mo, Pd, Ru, Re, Cu, Mg, Ca, Sr, Ba, Mn, Co, Zn and Cd.

6. The composite of claim 1,
wherein an amount of the nanoparticle is 0.001 part by weight to 10 parts by weight with respect to 100 parts by weight of the amorphous isotropic carbon compound.

7. The composite of claim 1,
wherein a specific surface area of the amorphous isotropic carbon compound is 50 m²/g to 500 m²/g.

8. The composite of claim 1,
wherein the nanoparticle is located at a (6,6)-edge, a (5,4)-edge, a (9.6)-edge, a (6,5)-edge, a (9,4)-edge, or a (6,4)-edge of the amorphous isotropic carbon compound.

9. The composite of claim 1,
wherein the amorphous catalyst composite is used for hydrogen adsorption and desorption, hydrogen evolution reaction (HER), oxygen reduction reaction (ORR), oxygen evolution reaction (OER), hydrogen oxidation reaction (HOR), photocatalyst or carbon dioxide reduction reaction.

10. A method of preparing an amorphous catalyst composite, comprising:
a process of dispersing a crystalline isotropic carbon compound in an alkaline solution;
a process of obtaining and calcining the dispersed material to obtain an amorphous isotropic carbon compound with a carbon defect; and
a process of impregnating the obtained amorphous isotropic carbon compound in a solution containing a nanoparticle precursor.

11. The method of claim 10,
wherein a concentration of the alkaline solution is 0.01 M to 0.08 M.

12. The method of claim 10,
wherein the alkaline solution includes KOH.

13. The method of claim 10,
wherein the process of dispersing the crystalline isotropic carbon compound in the alkaline solution is performed at 273 K to 310 K.
